(19) United States
(12) Patent Application Publication
(10) Pub. No.: US 2011/0176767 A1
(43) Pub. Date: Jul. 21, 2011

(54) OPTICAL FIBER CONNECTION STRUCTURE

(75) Inventors: Masatoshi Tanaka, Hyogo (JP); Masayoshi Hachiwaka, Hyogo (JP); Haruo Ooizumi, Hyogo (JP)

(73) Assignee: MITSUBISHI CABLE INDUSTRIES, LTD., Tokyo (JP)

(21) Appl. No.: 13/120,911

(22) PCT Filed: Aug. 21, 2009
(86) PCT No.: PCT/JP2009/004032

§ 371 Date: Mar. 24, 2011

(30) Foreign Application Priority Data
Sep. 24, 2008 (JP) 2008-244582

(51) Int. Cl. G02B 6/26

(52) U.S. Cl. 385/27; 385/96

(57) ABSTRACT

An optical fiber connection structure reducing MPI is provided. An intervening optical fiber 30 having a normalized frequency less than 2.405 and a length greater than or equal to 2 mm and less than or equal to 30 mm is interposed between a single-mode fiber 10a and a second single-mode fiber 20, and the second single-mode fiber 20 and the intervening optical fiber 30 are fused together. While transmission light is input through the first single-mode fiber 10a to the second single-mode fiber 20, a higher order mode is not generated in the second single-mode fiber 20.

### TECHNICAL FIELD

The present invention relates to optical fiber connection structures, and more particularly relates to an optical fiber connection structure in which transmission light is input through a first single-mode fiber to a second single-mode fiber.

### BACKGROUND ART

With the widespread use and development of the Internet, a large amount of information has been exchanged over communication networks, and thus, there has been a need to transmit and receive a larger amount of information at higher speed. Optical fibers are typically used for such transmission and reception of information. In particular, single-mode fibers made of quartz glass are suitable for high-capacity transmission of information, and are used in great quantities as communications fibers.

Normal single-mode fibers each have a structure in which a central portion of the single-mode fiber includes a core having a high refractive index and surrounded by a cladding with a low refractive index, and are fibers in which only a fundamental mode propagates through the core. While such a single-mode fiber is routed, as a main fiber from an information relay point to a user (e.g., a business office or a home), for example, by being disposed along a power transmission line, other optical fibers are used for routing into buildings and wiring in relay devices, and such other fibers and the main fiber are connected together through connectors, etc. In this case, an optical fiber which has a different structure from the main fiber and of which the bend resistance is enhanced can be used as an optical fiber for use in routing into buildings and wiring in relay devices. The reason for this is that there is a need to route optical fibers in small spaces in buildings or relay devices.

### CITATION LIST

### Non-Patent Document

NON-PATENT DOCUMENT 1: Journal of Lightwave Technology, vol. 9, No. 8, August 1991, pp. 954-958

### SUMMARY OF THE INVENTION

### Technical Problem

However, the phenomenon has been observed in which when cores of optical fibers connected to each other are misaligned at the interface between the optical fibers, light in a higher order mode is generated in one of the fibers to which transmission light is input, and when the higher order mode is coupled back to a fundamental mode at the fiber exit, this leads to interference (multi-path interference (MPI)), thereby causing power fluctuations. It has become clear that this phenomenon appears, as a problem, only after the coincidence of several conditions, and that when an optical fiber connected to a main fiber is a bend resistant optical fiber, the problem as described above tends to occur.

The present invention has been made in view of the foregoing point, and it is an object of the present invention to provide an optical fiber connection structure reducing MPI.

### Solution to the Problem

In order to solve the above problem, an optical fiber connection structure of the present invention is directed to the structure of portions of first and second single-mode fibers connected together in order to input transmission light through the first single-mode fiber to the second single-mode fiber. The second single-mode fiber includes a core, a first cladding, and a second cladding having a lower refractive index than that of the first cladding at a wavelength of the transmission light, the core, the first cladding, and the second cladding are arranged concentrically in a sequential order from a center of the second single-mode fiber, the second single-mode fiber has a normalized frequency greater than or equal to 2.405 and less than or equal to 3.9, and an intervening optical fiber having a normalized frequency less than 2.405 and a length greater than or equal to 2 mm and less than or equal to 30 mm is interposed between the first single-mode fiber and the second single-mode fiber while being fused to an end of the second single-mode fiber.

Here, cores are portions of single-mode fibers through which transmission light is passed, and the first and second claddings are portions of single-mode fibers serving to confine the transmission light. The transmission light may slightly penetrate the first and second claddings. The normalized frequency v is represented by the following expression 1:

V²=k²(n1²−n0²)a² Expression 1

where the character k is the wave number of the transmission light, the character n1 is the core refractive index, the character n0 is the cladding refractive index, and the character a is the core radius.

Preferably, the second single-mode fiber further includes a third cladding outside the second cladding, the core has a diameter greater than or equal to 8.2 μm and less than or equal to 10.2 μm, the first cladding has a lower refractive index than that of the core at the wavelength of the transmission light and an outer diameter greater than or equal to 30 μm and less than or equal to 45 μm, the second cladding has a thickness greater than or equal to 7.4 μm, and a relative index difference between the first cladding and the second cladding is greater than or equal to 0.5%. The reason for this is that when the relative index difference between the first cladding and the second cladding is small, this increases the bending loss.

The first single-mode fiber and the second single-mode fiber can be connected together through a connector, and the intervening optical fiber can be contained inside the connector.

In one embodiment, a third single-mode fiber having a length greater than or equal to 2 mm and less than or equal to 30 mm is further disposed while being fused to an end portion of the intervening optical fiber located near the first single-mode fiber. A core diameter of the third single-mode fiber can be identical with that of the first single-mode fiber.

### Advantages of the Invention

Since an optical fiber connection structure of the present invention is configured such that an intervening optical fiber having a normalized frequency less than 2.405 is interposed between first and second single-mode fibers while being fused to the second single-mode fiber, this can reduce transmission of light in a higher order mode through the second single-mode fiber, thereby reducing MPI.

### BRIEF DESCRIPTION OF THE DRAWINGS

FIG. 1 is a schematic view of connection of optical fibers according to a first embodiment.

FIG. 2(a) is a schematic cross-sectional view of a second single-mode fiber, and FIG. 2(b) is a refractive index profile.

FIG. 3 is a schematic view of connectors.

FIG. 4 is a schematic view of connection of optical fibers according to a second embodiment.

FIG. 5 is a schematic view of connection of three optical fibers for explaining MPI.

### DESCRIPTION OF EMBODIMENTS

Before description of embodiments of the present invention, how MPI occurs when optical fibers are connected together will be described with reference to FIG. 5.

When two single-mode fibers are connected together, and light is input through one of the single-mode fibers to the other single-mode fiber, a fundamental mode LP01 (1) is input through the first fiber 10a′ to the second fiber 20′. Here, when cross sections of cores 11 and 21 of both of the fibers 10a′ and 20′ are misaligned at the interface C6 between the fibers 10a′ and 20′ without being exactly aligned, little light in a higher order mode LP11 (2) is generated at the interface C6. When the second fiber 20′ is a normal single-mode fiber with a single cladding, light in the mode LP11 (2) is lost after the travel of the light for a very short distance, and thus, only light in the mode LP01 (1) is transmitted.

Here, a situation where connected portions of cores are misaligned denotes a situation where when cross sections of two cores have the same shape and the same size, a portion of one of the cross sections does not overlap with the other cross section, and a situation where when cross sections of two cores have different sizes, a portion of the smaller one of the core cross sections does not overlap with the larger core cross section.

By contrast, when the second fiber 20′ is a fiber of which the bending loss is reduced, the second fiber 20′ includes a cladding 22 including a plurality of layers with different refractive indexes in order to increase the bend resistance, and the latter of a cladding layer being in contact with the core and an immediately surrounding cladding layer has a lower refractive index than that of the former thereof. With such a structure, the mode LP11 (2) is less likely to be attenuated, and light in the mode LP11 (2) is transmitted to the exit end of the fiber 20′ over the length of the fiber 20′ used in a building or a relay device. While the second fiber 20′ is connected at its exit end to a single-mode fiber lob', etc., near a device, the mode LP11 (2) is coupled back to the mode LP01 (1) at the interface C3′ between the fibers, thereby causing MPI. Furthermore, since the mode LP01 (1) and the mode LP11 (2) are transmitted through the fiber 20′ at different speeds, the re-coupling causes noise.

When interference occurs as described above, optical power I is represented, as described in NON-PATENT DOCUMENT 1, by the following expressions 2:

I=A+B cos(Φ), D=2πL·Δn/λ Expressions 2

where the characters A and B are coefficients, the character L is the fiber length, the character Δn is the difference between the group index of the mode LP01 and that of the mode LP11, and the character λ is the wavelength of transmission light. As seen from Expressions 2, since the difference Δn varies with a variation in temperature, the optical power I fluctuates.

In order to prevent such power fluctuations, cores may be prevented from being misaligned at the interface C6. However, since, in connection between optical fibers through connectors, end surfaces of the optical fibers fixed by the connectors are fixed while being opposed to each other, misalignment of cores at the interface cannot be completely eliminated because end surfaces of the cores cannot be located to completely coincide with each other with the current mechanical accuracy of connectors, and the centers of the optical fibers themselves are displaced from the core centers. When cores are observed using a microscope to splice optical fibers, this can prevent core misalignment. However, when fusion splicing is used for routing into buildings and wiring in relay devices, this increases cost and makes it difficult to ensure a workspace, and thus, the use of fusion splicing is very difficult in practice.

The present inventors have conducted various studies in view of the above problem, and have arrived at the present invention.

Embodiments of the present invention will be described below in detail with reference to the drawings. In the following drawings, for simplicity, like reference characters have been used to designate components having substantially the same functions.

### First Embodiment

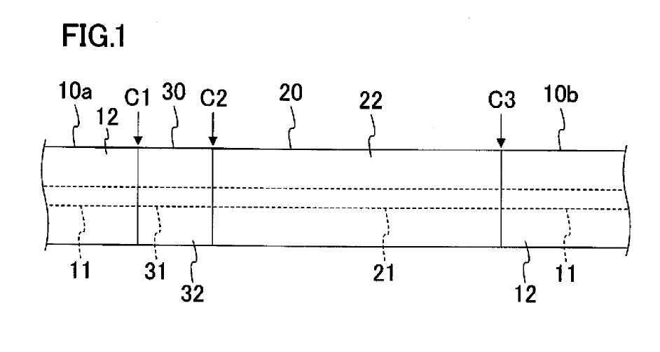

A first embodiment is directed to a fiber connection structure including a first single-mode fiber (hereinafter referred to as the first SMF) 10a which is an input single-mode fiber, an output SMF 10b, and a second SMF 20 interposed therebetween as illustrated in FIG. 1. The first SMF 10a and the output SMF 10b each have a single cladding 12, are normal single-mode fibers having high bending loss, and are both the same type of fibers having the same core diameter and the same cladding diameter. The second SMF 20 is a bend resistant fiber having lower bending loss than that of the first SMF 10a and that of the output SMF 10b, and an intervening optical fiber 30 is fusion spliced to the end of the second SMF 20 connected to the first SMF 10a.

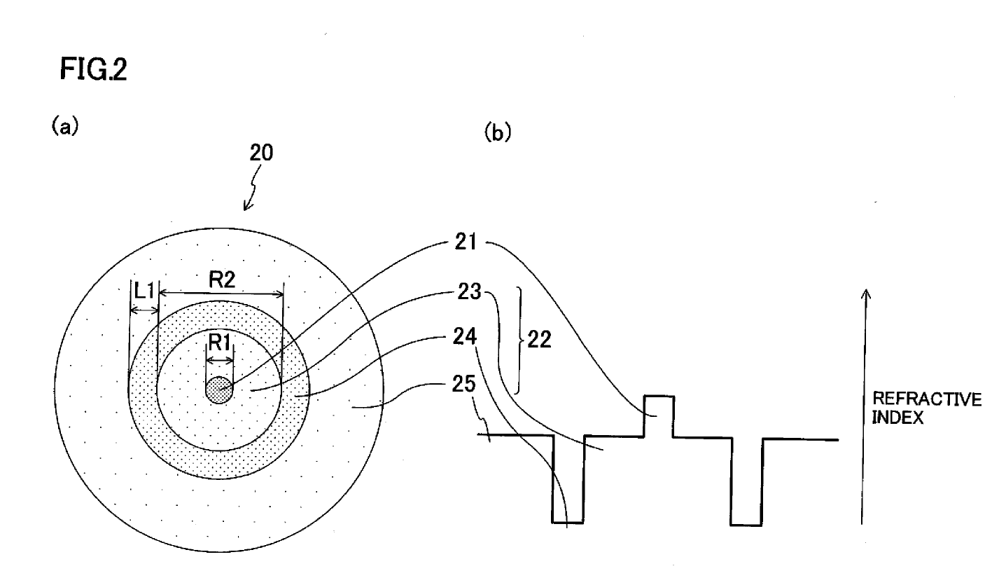

A cladding 22 of the second SMF 20 includes a plurality of concentric layers as illustrated in FIG. 2. The second SMF 20 is configured to include a core 21, a first cladding 23, a second cladding 24, and a third cladding 25 in a sequential order from the fiber center.

The core 21 is produced by doping quartz with germanium, and has a high refractive index, and the diameter R1 of the core 21 falls within a range of greater than or equal to 8.2 μm and less than or equal to 10.2 μm. The first cladding 23 is made of pure quartz to surround the outer surface of the core 21, and has a lower refractive index than that of the core 21, and the outer diameter R2 of the first cladding 23 falls within a range of greater than or equal to 30 μm and less than or equal to 45 μm. The second cladding 24 surrounds the outer surface of the first cladding 23, and has a lower effective refractive index than that of the first cladding 23; the relative index difference between the first cladding 23 and the second cladding 24 is greater than or equal to 0.5%; and the thickness L1 of the second cladding 24 is greater than or equal to 7.4 μm (in this embodiment, 10 μm). The third cladding 25 surrounds the outer surface of the second cladding 24, and has a higher refractive index than that of the second cladding 24, and the relative index difference between the third cladding 25 and the second cladding 24 is greater than or equal to 0.5%. The outer diameter of the third cladding 25 is 125 μm. The above-described refractive indexes denote refractive indexes at the wavelength of transmission light.

In order to allow the relative index difference between the second cladding 24 and the third the cladding 25 to be greater than or equal to 0.5%, the third cladding 25 may be made of pure quartz, and the second cladding 24 may be obtained by doping quartz with boron or fluorine. Alternatively, holes may be formed in portions of a region, which corresponds to the second cladding 24, of the second SMF 20 to extend along the core, and thus, the effective refractive index of the entire region corresponding to the second cladding 24 may be reduced. In the second SMF 20, the third cladding 25 serves as a support, and the first and second claddings 23 and 24 serve to confine light. Therefore, the third cladding 25 may be eliminated by increasing the thickness of the second cladding 24.

Since the first SMF 10a, the output SMF 10b, and the second SMF 20 are single-mode fibers, they each have a normalized frequency greater than or equal to 2.405. The normalized frequency of the second SMF 20 is preferably less than or equal to 3.9.

Assume that the first SMF 10a and the output SMF 10b are, e.g., optical fibers which each include the core 11 obtained by doping quartz with germanium and the cladding 12 made of quartz, in which the relative index difference between the core 11 and the cladding 12 is 0.35%, and of which the core diameter is 9 μm. In this case, when the wavelength of transmission light is 1.31 μm, the normalized frequency of each of the first SMF 10a and the output SMF 10b is 2.62.

The intervening optical fiber 30 is an optical fiber having a normalized frequency less than 2.405 and a length greater than or equal to 2 mm and less than or equal to 30 mm. As seen from Expression 1, the magnitude of the normalized frequency can be determined by adjusting the refractive indexes of a core 31 and a cladding 32 or by adjusting the diameter of the core 31. For example, when the intervening optical fiber 30 is an optical fiber which includes the core 31 obtained by doping quartz with germanium and the cladding 32 made of quartz, in which the relative index difference between the core 31 and the cladding 32 is 0.35%, and of which the core diameter is 8 μm, the normalized frequency of the intervening optical fiber 30 is 2.33. Specifically, when the intervening optical fiber 30 is the same as each of the first SMF 10a and the output SMF 10b except for the core diameter, and the core diameter of the intervening optical fiber 30 is 1 μm less than that of each of the first SMF 10a and the output SMF 10b, the normalized frequency of the intervening optical fiber 30 is less than 2.405. The normalized frequency of the intervening optical fiber 30 is preferably greater than or equal to 1.0. The reason for this is that when the normalized frequency is less than 1.0, the mode field diameter becomes too small, thereby increasing the splice loss.

The intervening optical fiber 30 and the second SMF 20 are fusion spliced together at the interface C2 therebetween. Since, in this fusion splicing, the locations of the cores of both the fibers at the interface between the fibers are adjusted while being observed using a microscope to prevent end portions of the cores from being misaligned, the cores are not misaligned. As described above, the cores are fused together at the interface C2 without being misaligned, and thus, when transmission light is input through the intervening optical fiber 30 to the second SMF 20, a mode LP11 is not generated. Furthermore, the intervening optical fiber 30 has a normalized frequency less than 2.405, and thus, even with the mode LP11 generated at the interface C1 between the first SMF 10a and the intervening optical fiber 30 due to core misalignment, the mode LP11 is blocked in the intervening optical fiber 30 and is not transmitted. Therefore, only a mode LP01 exists at the interface C2 between the intervening optical fiber 30 and the second SMF 20. Specifically, since only light in the mode LP01 is input to the second SMF 20 without being affected by the mode LP11, and the mode LP11 is not generated at the interface C2, MPI is not caused at the interface C3 between the second SMF 20 and the output SMF 10b. Moreover, interdiffusion of dopants is caused at the interface C2 by thermal diffusion, thereby reducing the splice loss.

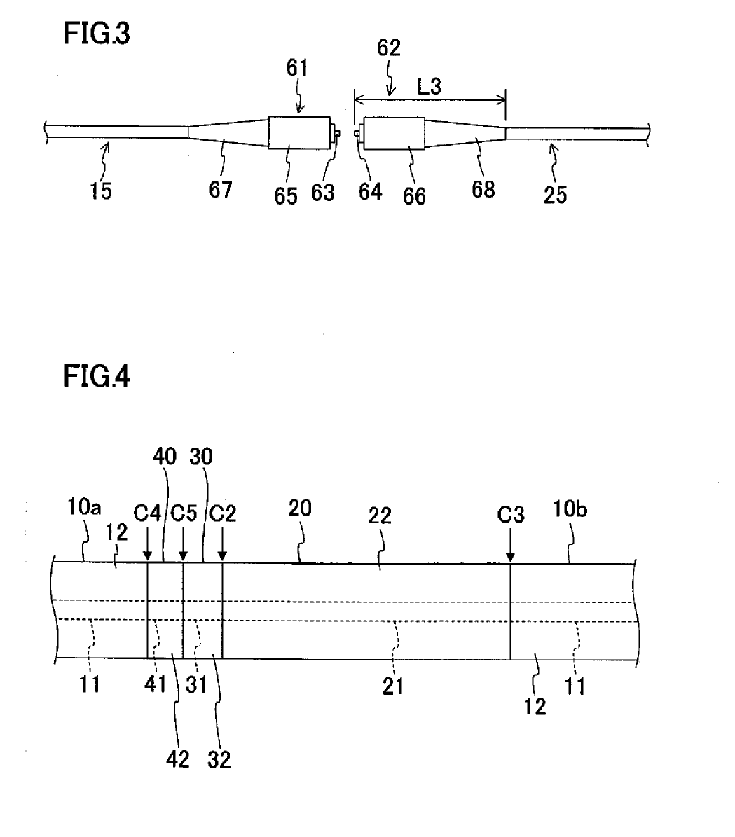

The above-described connection between optical fibers is provided using connectors 61 and 62 illustrated in FIG. 3. One ends of a coated optical fiber 15 obtained by coating the first SMF 10a and a coated optical fiber 25 obtained by coating the second SMF 20 are fitted with the connectors 61 and 62, respectively. Ferrules 63 and 64 are contained in the connectors 61 and 62, respectively, and while the first SMF 10a and the intervening optical fiber 30 are held in the ferrules 63 and 64, respectively, end surfaces of both of the fibers are exposed at ends of the ferrules 63 and 64. The two connectors 61 and 62 are connected and fixed to each other through adapters 65 and 66 with end portions of the ferrules 63 and 64 opposed to each other. The connection and fixation allows end surfaces of the first SMF 10a and the intervening optical fiber 30 to be fixed while being opposed to each other so that the centers of the end surfaces coincide with each other. The cores 11 and 31 of the first SMF 10a and the intervening optical fiber 30 may be connected to each other while being misaligned because the core of an optical fiber may deviate from the center of a cross section of the optical fiber, and the accuracies with which the connectors 61 and 62 are fabricated are not currently high enough to allow the centers of cores to coincide with each other. However, if optical fibers are fitted with connectors when shipped from the factory, the fibers can be easily connected together in a short time at the site of connection between fibers.

Bending of the connectors 61 and 62 is restricted to prevent the radius of curvature of portions of the optical fibers located inside the adapters 65 and 66 and protectors 67 and 68 adjacent to the adapters 65 and 66, respectively, from being reduced. The intervening optical fiber 30 is contained in the adapter 66 and the protector 68 (which combine together to form the connector 62), and is protected from excessive bending. Depending on the types of a connector, the length L3 of a portion, which is protected from bending, of a combination of the intervening optical fiber 30 and the second SMF 20 is 30-60 mm. The intervening optical fiber 30 is contained in the protective portion (inside the connector), and is protected from bending. Therefore, no bending loss is caused. Furthermore, the entire intervening optical fiber 30 is preferably contained in the ferrule 64 because the portion of the combination is reliably protected from bending. As long as the intervening optical fiber 30 has a length greater than or equal to 1 mm, the mode LP11 can be removed. However, in view of ease of fusion splicing operation, etc., the intervening optical fiber 30 preferably has a length greater than or equal to 2 mm.

Connectors are preferably used similarly to provide connection between the second SMF 20 and the output SMF 10b.

As seen from the above, in this embodiment, the intervening optical fiber 30 is interposed between the first SMF 10a and the second SMF 20, and is fusion spliced to the second SMF 20, thereby reducing MPI. This can reduce noise added to information to be transmitted, can also reduce the power fluctuations and noise variation with variation in temperature, and can improve transmission quality (error rate, etc.). Furthermore, since the intervening optical fiber 30 is short, such as 2-30 mm, and thus, the intervening optical fiber 30 is contained inside the corresponding connector without reducing the flexibility in designing the second SMF 20, the portion of the combination of the intervening optical fiber 30 and the second SMF 20 is protected from bending, thereby allowing the bending loss to be substantially zero.

### Second Embodiment

A second embodiment is different from the first embodiment in the structure of a portion of a second SMF 20 connected to a first SMF 10a, and the other features are identical with those in the first embodiment. Therefore, a difference from the first embodiment will be described below.

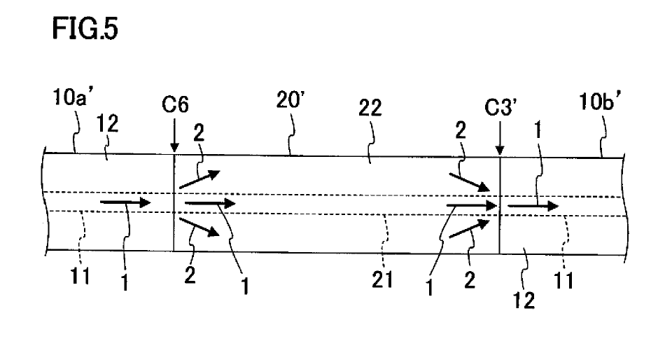

As illustrated in FIG. 4, a third SMF 40 is fusion spliced to an end portion of an intervening optical fiber 30 which is opposite to an end portion thereof fused to a second SMF 20. The intervening optical fiber 30 and the third SMF 40 are fused together at the interface C5 therebetween by fusion splicing using a microscope as described in the first embodiment. The third SMF 40 may be a fiber of the same type as the first SMF 10a, may be a fiber of the same type as the second SMF 20, or may be a fiber of another type. The diameter of a core 41 of the third SMF 40 is identical with that of a core 11 of the first SMF 10a.

In this embodiment, the third SMF 40 and the intervening optical fiber 30 are contained in a corresponding connector. The length of the third SMF 40 is greater than or equal to 2 mm and less than or equal to 30 mm.

In this embodiment, since the diameter of the core 41 of the third SMF 40 is identical with that of the core 11 of the first SMF 10a, the splice loss at the interface C4 therebetween can be lower than that in the first embodiment. Furthermore, this embodiment provides the same advantages as in the first embodiment.

### Other Embodiments

The above embodiments are set forth for the purposes of examples of the present invention, and the present invention is not limited to these examples. For example, an intervening optical fiber 30 may be interposed also between a second SMF 20 and an output SMF 10b. The structures of the first through third SMFs 10a, 20, and 40 and the intervening optical fiber 30 are not limited to the above-described examples, and an SMF which does not depart from the spirit of the invention can be used.

### INDUSTRIAL APPLICABILITY

As described above, the optical fiber connection structure according to the present invention reduces MPI, and is useful as an optical fiber connection structure, etc., for optical communications.

### DESCRIPTION OF REFERENCE CHARACTERS

10a First Single-Mode Fiber
11 Core
20 Second Single-Mode Fiber
21 Core
22 Cladding
23 First Cladding
24 Second Cladding
25 Third Cladding
30 Intervening Optical Fiber
40 Third Single-Mode Fiber
41 Core
61, 62 Connector

1. An optical fiber connection structure in which transmission light is input through a first single-mode fiber to a second single-mode fiber, wherein
the second single-mode fiber includes a core, a first cladding, and a second cladding having a lower refractive index than that of the first cladding at a wavelength of the transmission light,
the core, the first cladding, and the second cladding are arranged concentrically in a sequential order from a center of the second single-mode fiber,
the second single-mode fiber has a normalized frequency greater than or equal to 2.405 and less than or equal to 3.9, and
an intervening optical fiber having a normalized frequency less than 2.405 and a length greater than or equal to 2 mm and less than or equal to 30 mm is interposed between the first single-mode fiber and the second single-mode fiber while being fused to an end of the second single-mode fiber.

2. The optical fiber connection structure of claim 1, wherein
the second single-mode fiber further includes a third cladding outside the second cladding,
the core has a diameter greater than or equal to 8.2 μm and less than or equal to 10.2 μm,
the first cladding has a lower refractive index than that of the core at the wavelength of the transmission light and an outer diameter greater than or equal to 30 μm and less than or equal to 45 μm,
the second cladding has a thickness greater than or equal to 7.4 μm, and
a relative index difference between the first cladding and the second cladding is greater than or equal to 0.5%.

3. The optical fiber connection structure of claim 1, wherein
the first single-mode fiber and the second single-mode fiber are connected together through a connector, and
the intervening optical fiber is contained inside the connector.

4. The optical fiber connection structure of claim 1,
wherein a third single-mode fiber having a length greater than or equal to 2 mm and less than or equal to 30 mm is further disposed while being fused to an end portion of the intervening optical fiber located near the first single-mode fiber.

5. The optical fiber connection structure of claim 4, wherein
a core diameter of the third single-mode fiber is identical with that of the first single-mode fiber.
